(19) United States
(12) Patent Application Publication
(10) Pub. No.: US 2007/0005865 A1
(43) Pub. Date: Jan. 4, 2007

(54) Enforcing global ordering using an inter-queue ordering mechanism

(76) Inventors: Bryan L. Spry, Portland, OR (US); Jeffrey D. Gilbert, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/171,974

(22) Filed: Jun. 29, 2005

(51) Int. Cl. G06F 13/36

(52) U.S. Cl. 710/306

(57) ABSTRACT

An arrangement is provided for efficiently enforcing global ordering in a computing system using an inter-queue ordering mechanism (IQOM). The IQOM may be located in a bridge (e.g., a caching bridge) coupling two interconnects: an internal interconnect to connect different processing units (e.g., processing cores inside a processor or a single core processor) and a system interconnect to connect different processors and/or different internal interconnects. The bridge handles transactions from two directions: inbound—from the system interconnect to an internal interconnect, and outbound—from an internal interconnect to the system interconnect. The IQOM may be used to enforce strict ordering among inbound transactions and among outbound transactions separately and thus allow certain inbound transactions that occur on the system interconnect after an outbound transaction to be completed before the outbound transaction.

### BACKGROUND

1. Field

This disclosure relates generally to processors and, more specifically, to enforcing global ordering of transaction executions in a computing system.

2. Description

It is common that a multiple processor computing system has two types of independent interconnects (e.g., buses), for example, one may be used to connect internal multiple cores with their shared cache (“internal interconnect”) within a processor and the other may be used to connect multiple processors (“system interconnect”). When such two types of interconnects exist, it is necessary to ensure that a program order is preserved across these two types of interconnects.

Executing a computer program generally results in issuing a series of transactions. The program executes in an order (“program order”) and expects the transactions that it issues to affect the system in the program order. In practice, a computer system may choose to cache memory and re-order certain transactions to achieve efficient operations. In doing so, the computer system needs to insure that the executing program “sees” the transactions being handled in the program order. In other words, the transactions must have the same effect visible from the program after caching and re-ordering as they would have had without caching or re-ordering.

If there is only one interconnect, a program order can be guaranteed by mechanisms inherited in the interconnect unit. When there are two or more interconnects (e.g., a processor internal bus and a system bus), however, a bridge (e.g., a bus bridge or a caching bridge) may be needed to couple these interconnects. In such cases, a processor's interconnect unit may no longer have sufficient system visibility to insure a program order on its own because it does not have control over the transaction execution order over a system interconnect. Thus, it is desirable for the bridge to have the ability of enforcing global ordering under which each program order may be maintained across multiple interconnects in a multiple processor system.

### BRIEF DESCRIPTION OF THE DRAWINGS

The features and advantages of the disclosed subject matter will become apparent from the following detailed description of the subject matter in which:

FIG. 1 is one example block diagram of a multi-processor system using caching bridges to couple different interconnects in the system;

FIG. 2 is another example block diagram of a multi-processor system using caching bridges to couple different interconnects in the system;

FIG. 3 is an example block diagram of a computing system using caching bridges to couple different interconnects in the system;

FIG. 4 shows one example block diagram of a caching bridge;

FIGS. 5A and 5B illustrate different approaches to enforce global ordering in a computing system;

FIG. 6 shows one example block diagram of an inter-queue ordering mechanism that is used to enforce global ordering in a computing system;

FIG. 7 illustrates one example queue used by the inter-queue ordering mechanism; and

FIG. 8 illustrates a flowchart of one example process for enforcing global ordering using an inter-queue ordering mechanism.

### DETAILED DESCRIPTION

One goal of enforcing global ordering in a computing system with a bridge is to ensure that any program order is preserved across different interconnects. For example, regardless of the system interconnect's ability of re-ordering transactions to improve operation efficiency, it must be ensured that transactions are processed on the system interconnect in the order they are issued by a processor. One way to ensure a program order across a bridge is to enforce strict ordering, i.e., to serialize transaction completions on the system interconnect. In other words, a preceding transaction must be completed before any transactions following it can be completed. Although the strict ordering approach can ensure a program order, it makes a computing system very inefficient. A principal source of a system system's efficient performance is overlapped/re-ordered operations of its different pieces. Throttling the system interconnect to enforce strict ordering would be extraordinarily wasteful.

According to an embodiment of techniques disclosed in the present application, independent system interconnect operations are allowed to the greatest extent by distinguishing between cases where the order of transactions must be preserved and where strict ordering can be relaxed, and constraining transaction processing only when ordering is required. A bridge that couples two interconnects (e.g., an internal interconnect and a system interconnect) may be utilized to enforcing global ordering. The bridge typically handles transactions from two directions: outbound (from an internal interconnect to a system interconnect) and inbound (from a system interconnect to an internal interconnect). From a program correctness standpoint, so long as outbound and inbound transactions retain their system interconnect ordering within their respective groups, it is completely permissible to let inbound transactions pass completions on the path from the system interconnect to the internal interconnect. An Inter-Queue Ordering Mechanism (IQOM) may be used to achieve this purpose.

The IQOM may be located within a bridge that couples an internal interconnect and a system interconnect. The IQOM may comprise three separate queues: an outbound transaction queue (OTQ), an inbound transaction queue (ITQ), and a global ordering queue (GOQ). The OTQ may be used to ensure the strict completion order among outbound transactions. The ITQ may be used to ensure the strict completion order among inbound transactions. The GOQ may be used to enforce a non-uniform relative ordering policy: an inbound transaction that occurs after an outbound transaction on the system interconnect can be delivered by the bridge to the internal interconnect so long as the inbound transaction occurs before the completion of the outbound transaction on the system interconnect.

Reference in the specification to “one embodiment” or “an embodiment” of the disclosed subject matter means that a particular feature, structure or characteristic described in connection with the embodiment is included in at least one embodiment of the disclosed subject matter. Thus, the appearances of the phrase “in one embodiment” appearing in various places throughout the specification are not necessarily all referring to the same embodiment.

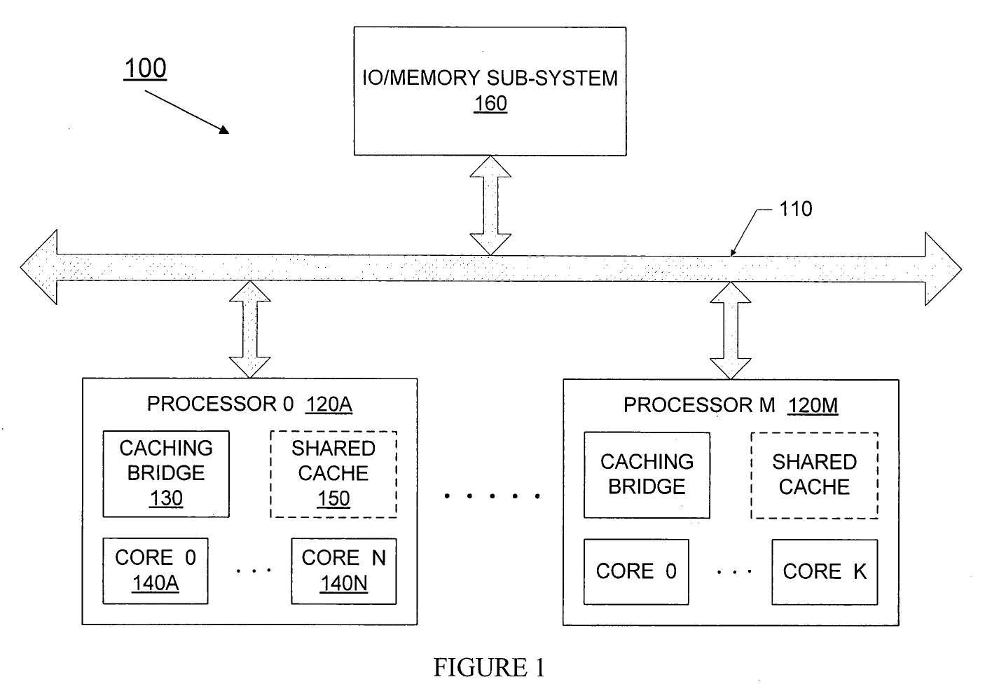

FIG. 1 shows one example block diagram of a multi-processor system 100 using caching bridges to couple different interconnects in the system. Each processor (e.g., processor 0 (120A)) in system 100 may include multiple cores (e.g., core 0 (140A), . . . , core N (140N)). Each processor may have a shared cache (e.g., 150 in processor 0 (120A)), which is shared by all processing cores inside the processor. A shared cache may be on-die of a processor, it may be off-die of the processor, or it may be partly on-die and partly off-die of the processor. An internal interconnect (not shown in FIG. 1) may connect processing cores with the shared cache. In one embodiment, each processing core may have its own dedicated interconnect to connect it to the shared cache. In another embodiment, some or all of the processing cores may share one interconnect to connect them to the shared cache. System 100 may be referred to as a multi-core multi-processor system (MCMP). Processors in system 100 may be connected to each other using a system interconnect 110. System interconnect 110 may be a Front Side Bus (FSB). Each processor may be connected to Input/Output (IO) devices as well as memory 160 through the system interconnect. Each processor may have a caching bridge (e.g., 130 in processor 0 (120A)) to couple the internal interconnect(s) with system interconnect 110.

A caching bridge in a processor is responsible for receiving transactions from processing cores; looking up the shared cache and forwarding requests to the system interconnect if needed. It is also responsible for issuing incoming snooping transactions from the system interconnect to an appropriate core or cores inside the processor; delivering results from the system interconnect to the cores and updating the state of lines in the shared cache. The caching bridge may also enforce global ordering between a system interconnect and an internal interconnect.

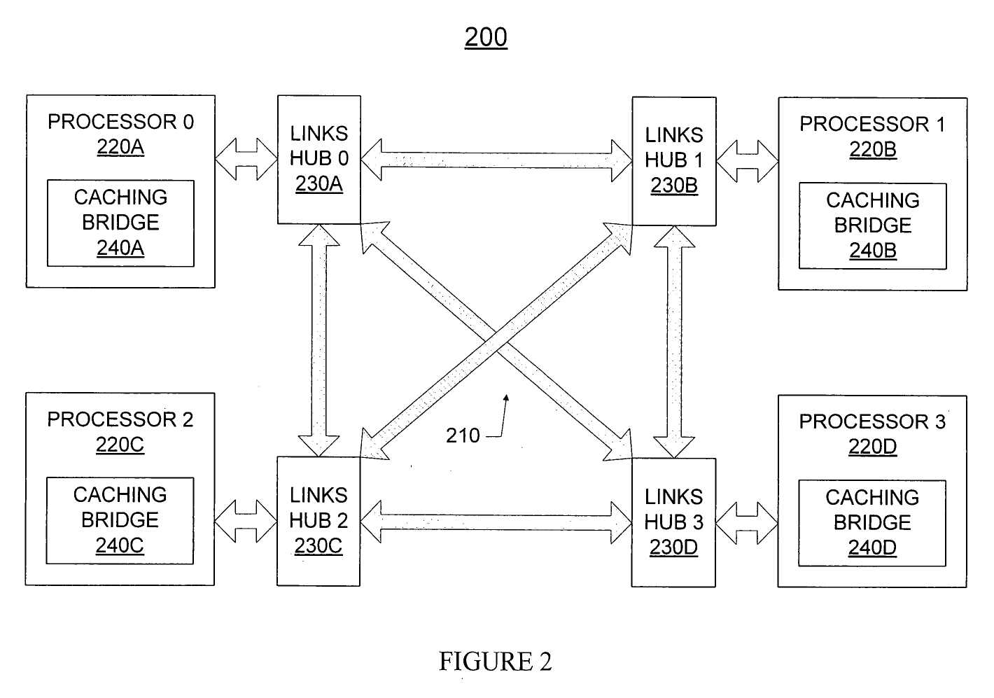

FIG. 2 is another example block diagram of a multi-processor system 200 using caching bridges to couple different interconnects in the system. In system 200, system interconnect 210 that connects multiple processors (e.g., 220A, 220B, 220C, and 220D) is a links-based point-to-point connection. Each processor may connect to the system interconnect through a links hub (e.g., 230A, 230B, 230C, and 230D). In some embodiments, a links hub may be co-located with a memory controller, which coordinates traffic to/from a system memory. Each processor may include multiple processing cores (not shown in FIG. 2), all of which may be associated with a shared cache (not shown in FIG. 2). The shared cache may be on-die, off-die, or partly on-die and partly off-die. Processing cores may be connected with the shared cache by an internal interconnect. Each processing core may have its own interconnect; some or all of the processing cores may share a common interconnect. Each processor may have a caching bridge (e.g., 240A, 240B, 240C, and 240D) to couple its internal interconnect(s) with system interconnect 210. The caching bridges may be utilized to enforce global ordering of transactions between internal interconnect(s) and system interconnect 210.

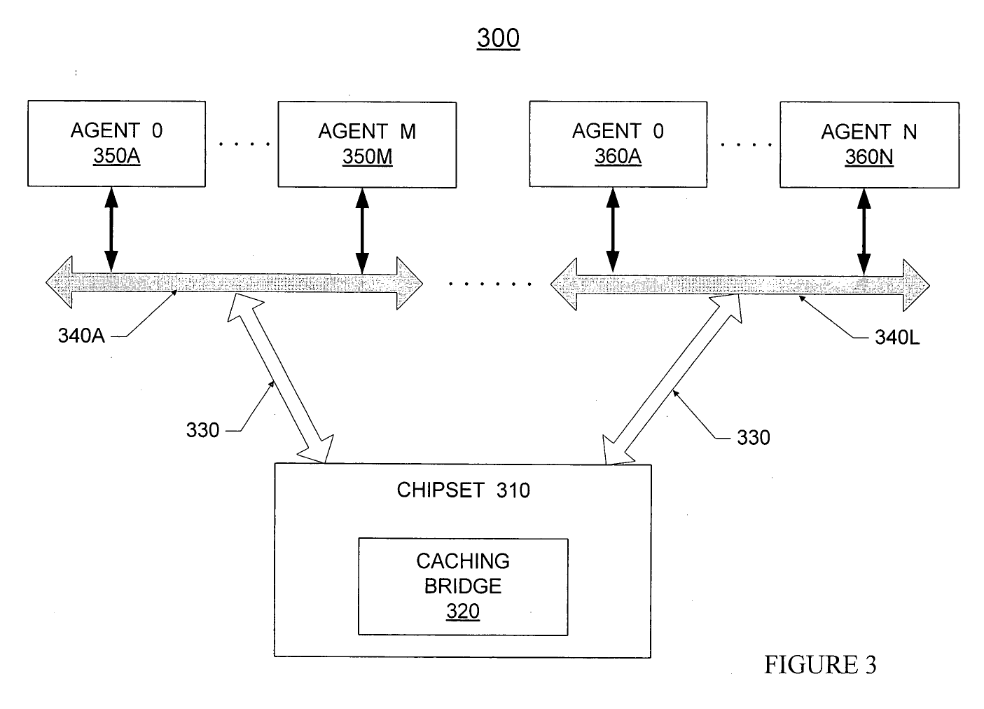

FIG. 3 shows an example block diagram of a computing system 300 using caching bridges to couple different interconnects in the system. System 300 may have multiple agents (e.g., 350A, 350B, . . . , 350M, 360A, 360B, . . . , 360N). Each agent may be processor, a network controller, an 10 device, etc. The number of agents in system 300 may be too large for only one system interconnect to connect them together along with the system memory sub-system (not shown in FIG. 3) because of electrical loading concerns. Thus, multiple agents may form different subgroups with each group having its own interconnect. For example interconnect 340A may connect agents 350A, 350B, . . . , 350M in one group; and interconnect 340L may connect agents 360A, 360B, . . . , 360N in another group. In one embodiment, a group of agents may have a cache shared by some or all of the agents in that group. One or more internal interconnects may be used to connect agents in the group to the shared cache. In another embodiment, an agent may be able to access caches associated with another agent in the same group through the group interconnect.

A chipset 310 may connect two or more different groups together through connection 330. Chipset 310 may also help couple a graphics circuit, 10 devices, and/or other peripherals to processors (e.g., 350A, 360N, etc.). Chipset 310 may include a caching bridge 320 to couple group interconnects (e.g., 340A, and 340L) together. Caching bridge 320 may help enforce global ordering of transactions among group interconnects (e.g., 340A, . . . , 340L). In one embodiment, caching bridge 320 may be physically inside chipset 310. In another embodiment, caching bridge 320 may be coupled with chipset 310 but not physically inside the chipset. Different groups of agents may also be connected to each other through other devices including networking devices.

If an agent in system 300 is a processor, the processor may be single-core or multi-core processors. A multi-core processor may have its own caching bridge to couple its own internal interconnect with the group interconnect or directly with other agents through caching bridge 320 in chipset 310. A caching bridge within a multi-core,processor may coordinate with caching bridge 320 to enforce global ordering of transactions between a multi-core processor's own internal interconnect and group interconnects. Although not shown in FIG. 3, different groups of agents may be connected through an FSB-based system interconnect or a links-based point-to-point system interconnect. Similarly, agents within a group may also be connected through a FSB-like-based interconnect or a links-based point-to-point interconnect.

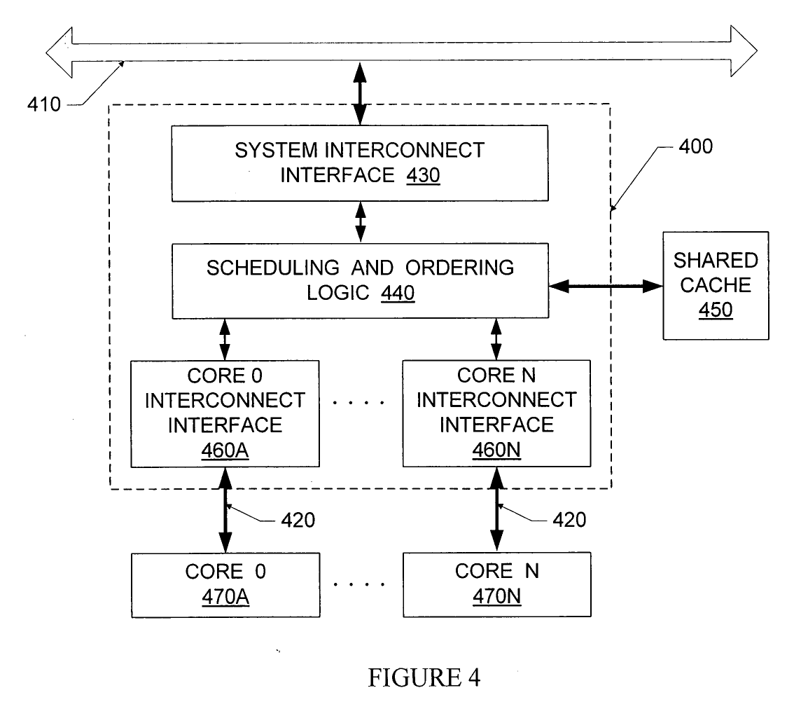

FIG. 4 shows one example block diagram of a caching bridge 400. Caching bridge 400 couples internal interconnect(s) 420 with a system interconnect 410 in an MCMP system. Internal interconnect(s) 420 connect different cores (e.g., core 0 (470A), . . . , core N (470N)) with a shared cache 450. Note that a multi-core processor is used as one example to illustrate how a caching bridge works and a caching bridge can be used in a multiple single-core processor system such as the one shown in FIG. 3. In one embodiment, each processing core may have its own interconnect to connect to the shared cache. In another embodiment, some or all of the processing cores may share a common interconnect to connect to the shared cache. In a multi-core processor case, shared cache 450 may be on-die along with caching bridge 400; it may also be off-die; or it may be partly on-die and partly off-die. In other cases, shared cache 450 may be co-located with caching bridge 400 on the same die or on different dies. Caching bridge 400 may connect to system interconnect 410 through a system interconnect interface 430, and to internal interconnect(s) 420 through core interconnect interfaces such as 460A and 460N.

Caching bridge may also include scheduling and ordering logic 440. The scheduling and ordering logic may maintain the coherency of the cache lines present in shared cache 450. The scheduling and ordering logic schedules requests from cores to the shared cache and the system interconnect so that each core receives a fair share of resources in the caching bridge. A caching bridge typically handles transactions from two directions: outbound (from an internal interconnect to a system interconnect) and inbound (from a system interconnect to an internal interconnect). Inbound transactions are used to maintain system level cache coherency and are often referred to as snooping transactions. Snooping transactions may remove cache lines (also known as invalidation) in the shared cache when another agent requires exclusive ownership—generally to obtain write privileges for the snoop originator. Snooping transactions may also demote cache line access rights from ‘exclusive’ to ‘shared’ so that the snoop originator can read the line without necessarily removing it from other agents. Outbound transactions form the conjugate to snooping transactions: when a core wants write permission, it issues a read that invalidates other cores and other cache hierarchies. A simple core line read becomes, to other agents, a snoop that allows other agents to retain the cache line in ‘shared’ state. Note that not all read transactions or snoops have to be sent to the system interconnect. For example, if a cache line to be read can be found in a cache shared by different processing cores inside a processor and has the sufficient state, the read transaction does not need to be sent out to the system interconnect and accordingly there is no snoop corresponding to this read transaction on the system interconnect.

Scheduling and ordering logic 440 may ensure that inbound transactions received from the system interconnect are sent to appropriate core(s), and eventually deliver the correct results and data to the requesting core. An outbound transaction (e.g., a core's request for data) may be deferred by the scheduling and ordering logic (for example, the requested data is not present in the shared cache or it is present but also owned by other agents in the system). No particular order of completion is guaranteed for deferred transactions. In other words, the transaction ordering observed on the system interconnect may be quite different from the transaction ordering observed by cores. To preserve program orders, however, caching bridge 400, particularly, scheduling and ordering logic 440, needs to enforce global ordering, i.e., to ensure correct program orders expected by program-hosting cores between internal interconnects (e.g., 420) and system interconnect 410. A caching bridge typically enforces global ordering in a multi-processor system at a transaction level, independent of the underlying physical, link or transport layers used to communicate the transactions.

Although the IQOM is illustrated through a caching bridge in an MCMP system in FIG. 4, its application is limited to this context. An IQOM can be used in any computing system to enforce global ordering between two or more interconnects.

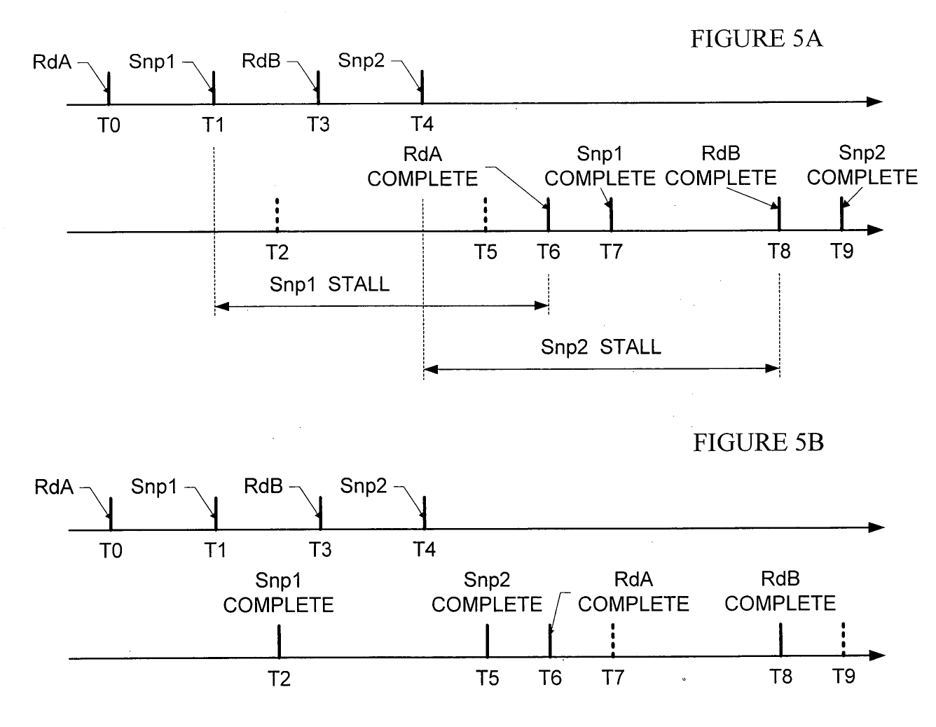

FIGS. 5A illustrates an approach to enforcing global ordering based on strict ordering. As shown in the figure, the order of transactions observed on the system interconnect is: RdA43 Snp1→RdB→Snp2, where “Rd” represents for a read transaction (an outbound transaction from the point of a caching bridge's view), and “Snp” represents for a snoop transaction (an inbound transaction from the point of a caching bridge's view). RdA cannot be completed until T6 and RdB cannot be completed until T8; while Snp1 could be completed at T2 and Snp2 could be completed at T5 if they were allowed. According to the strict ordering approach, RdA, Snp1, RdB, and Snp2 must be completed in this order. Thus, Snp1 must be stalled from T2 till T6, and Snp2 must be stalled from T4 till T8. Typically, the time required to complete a snoop transaction is less than the time required to complete a read transaction. Such a strict ordering based approach to enforcing global ordering could cause pervasive snoop result delays (snoop stalling).

FIG. 5B illustrates an approach to enforcing global ordering according to an embodiment of techniques disclosed in this application. Transactions RdA, Snp1, RdB, and Snp2 occur in the same order as shown in FIG. 5A. Instead of letting Snp1 wait until RdA is completed and Snp2 wait until RdB is completed, this approach allows Snp1 to be completed at T2 (before RdA is completed) and Snp2 to be completed at T5 (before RdB is completed). Using this approach, the order of outbound transactions (RdA→RdB) is strictly preserved among themselves and the order of inbound transactions (Snp1→Snp2) is also strictly preserved among themselves. This approach accelerates the relative in-order delivery of snoops to processing units with respect to read transaction completions but does not violate any program order.

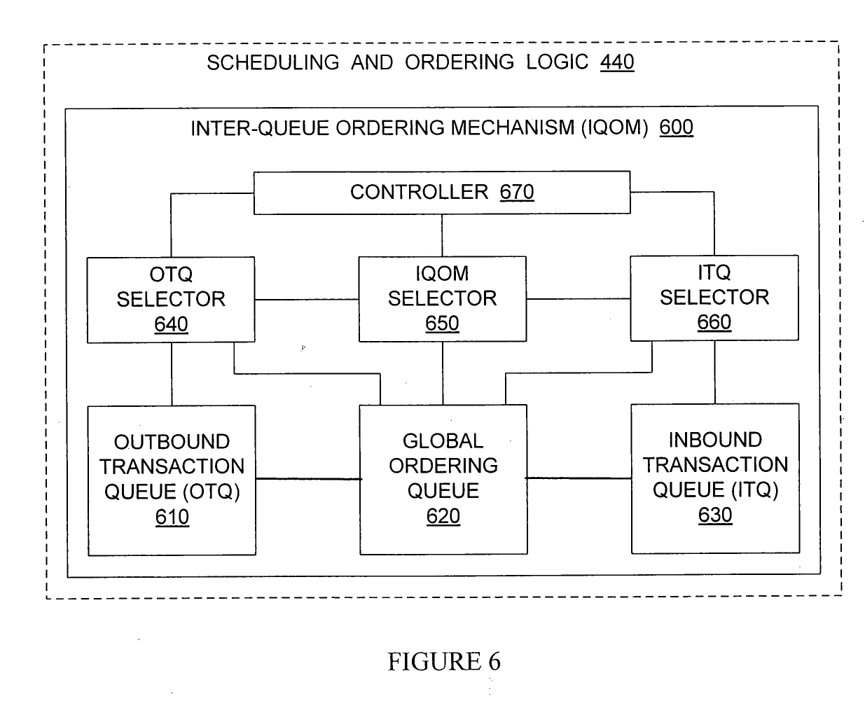

FIG. 6 shows one example block diagram of an inter-queue ordering mechanism (IQOM) 600 that is used to enforce global ordering without causing pervasive delays for inbound transaction completions in a computing system. In one embodiment, the IQOM may be a part of scheduling and ordering logic 440 as shown in FIG. 4. The IQOM comprises three separate queues: an outbound transaction queue (OTQ) 610, an inbound transaction queue (ITQ) 630, and a global ordering queue (GOQ) 620. The OTQ may be used to ensure that completions of outbound transactions are delivered to processing unit(s) in the same order as they occurred on the system interconnect, i.e., to enforce the strict completion order among outbound transactions. The ITQ may be used to ensure that ‘older’ inbound transactions are processed before ‘younger’ inbound transactions, i.e., to enforce the strict completion order among inbound transactions. The GOQ may be used to enforce a non-uniform relative ordering policy: an inbound transaction that occurs after an outbound transaction on the system interconnect can be delivered by the bridge to processing unit(s) via the internal interconnect so long as the inbound transaction occurs before the completion of the outbound transaction on the system interconnect.

Any outbound transaction from a processing unit (e.g., a core, a single-core processor, an 10 device, a network controller, etc.) is allocated into OTQ 610 of a caching bridge associated with the processing unit with an indication of its age. An OTQ selector 640 may be used to select the oldest outbound transaction in the OTQ. Any inbound transaction from the system interconnect to the processing unit is allocated into ITQ 630 of the caching bridge with an indication of its age. An ITQ selector 660 may be used to select the oldest outbound transaction in the ITQ. All of the inbound and outbound transactions may be allocated into GOQ 620 of the caching bridge with an indication of their ages as observed on the system interconnect. The IQOM is capable of tracking, through the system interconnect, whether an outbound transaction in the GOQ is completed on the system interconnect and is ready to be delivered to the issuing processing unit. A GOQ selector may be used to select the oldest transaction among all the inbound transactions and all the outbound transactions that are ready to be delivered to the issuing processing unit (“completion transactions”) in the GOQ.

The IQOM may also comprise a controller 670 to determine which transaction among those selected by the ITQ, OTQ, and GOQ selectors should be selected and delivered to a corresponding processing unit for processing. At any one time, the controller may have a choice between the oldest inbound transaction (if any) and the oldest completion transaction (if any). Three rules may be used to select a queue whose top (oldest) entry will be issued to a processing unit at a processing unit issue point:

(1) If there is a completion transaction, which is the oldest in the GOQ, ready for processing, and an inbound transaction (if any) appears on the system interconnect after the completion transaction, then select the completion transaction for processing by the processing unit;

(2) If there is no completion transaction ready for processing and there is an inbound transaction ready, which is the oldest in the ITQ, then select the inbound transaction for processing by the processing unit; and

(3) If neither rule (1) nor rule (2) results in a selection, then wait until the next processing unit issue point to try again.

There may be a variety of extensions to this basic framework for selecting a transaction at a processing unit issue point. For example, some FSBs include the ability to defer a transaction. When that happens, the entry corresponding to this deferred transaction in a queue (ITQ or OTQ) is transferred to a defer pool. At a later point, when the deferred transaction is completed on the system bus, that deferred entry is transferred back to its corresponding queue. In some cases, additional rules may be needed to select a transaction at a processing unit issue point. For example, when additional sub-interconnects are used for completing a transaction, specific rules about relative ordering between all interconnects need be established.

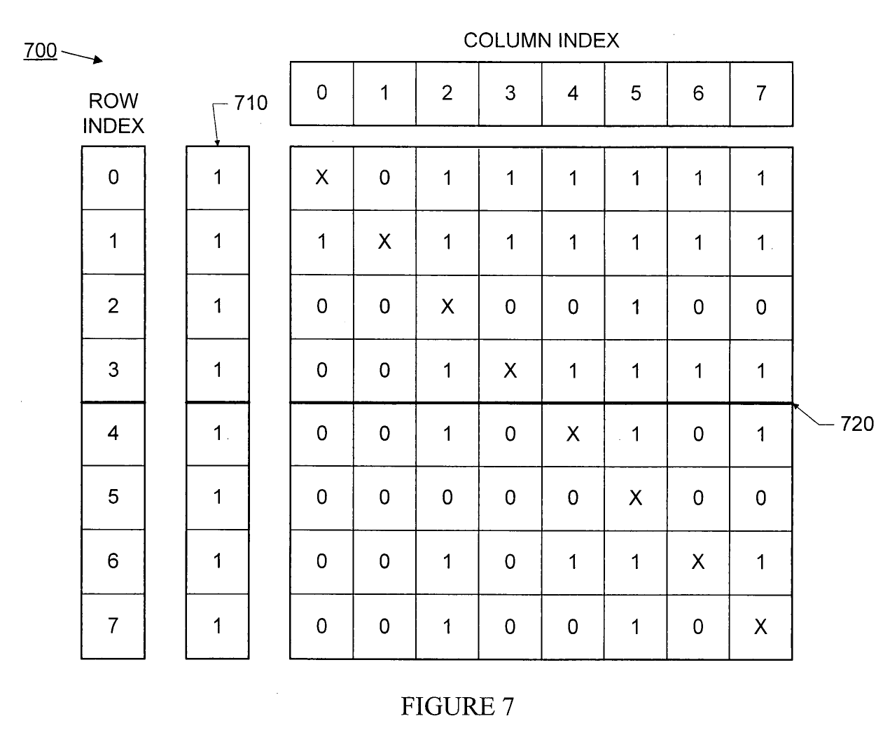

FIG. 7 illustrates one example queue 700 used by the inter-queue ordering mechanism for the GOQ. Queue 700 includes an age order matrix (AOM) 720 and a valid bit column 710. Each entry in the ITQ and OTQ has a corresponding entry in the GOQ 700. There is a bit in valid bit column 710 corresponding to the entry. When an entry is first allocated into the AOM, its corresponding valid bit may be set to 1. When the entry is de-allocated (e.g., a deferred transaction is de-allocated), its corresponding valid bit may be set to 0. Only valid entries are considered when selecting a transaction for processing. AOM 720 comprises N rows and N columns, where N denotes the maximum number of transactions that the AOM may hold. The row index and the column index correspond to the index of a transaction, e.g., row 3 and column 3 corresponds to transaction 3. In one embodiment, the GOQ may be statically divided between inbound transactions and outbound transactions. Entries are allocated in the AOM at issuance on the system interconnect, with an indication of the order in which they appear on the system interconnect. Using this global ordering queue 700, the system may process the oldest entry. This ensures that the order in which inbound and outbound transactions are issued to processing units is the same as the order in which transactions appear on the system interconnect.

In this particular example as shown in FIG. 7, the AOM contains 8 transactions: t0, t1, t2, . . . , t8, all of which are valid. The age order (starting from the oldest) of these 8 transactions are as follows: t5, t2, t7, t4, t6, t3, t0, and t1. As the oldest transaction, t5 is allocated into the AOM with all bits in row 5 being set to 0 and all bits in column 5 being set to 1. Note that whichever the bit at row 5 and column 5 is set does not matter because t5 cannot be “older” or “younger” than itself. When t2 is allocated, the bit at row 2 and column 5 is set to 1; all the other bits in row 2 is set to 0; and all bits in column 2 except the bit at row 5 and column 2 are set to 1. Again the bit at row 2 and column 2 can be set either 0 or 1. All the other transactions (i.e., t7, t4, t6, t3, t0, and t1) can be allocated into the AOM in the similar manner. By allocating transactions according to its age in this manner, the position of a transaction can be easily found from the AOM by checking values of bits in its corresponding row or column. For example, bits 2 and 5 of column 7 are 0 (or bits 2 and 5 of row 7 are 1), thus, t2 and t5 are older than t7. If later, a transaction is de-allocated (e.g., t4), its corresponding valid bit is set to 0 so that it will not be considered when selecting the oldest completion transaction from the GOQ.

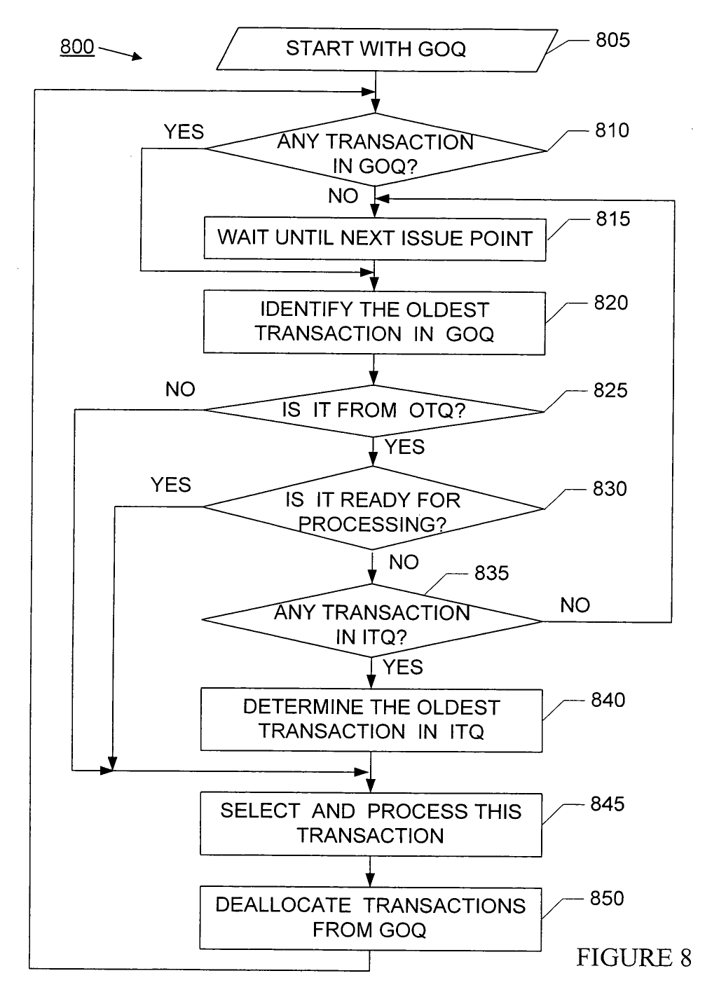

FIG. 8 illustrates a flowchart of one example process 800 for enforcing global ordering using an inter-queue ordering mechanism. Allocation of transactions into the GOQ and de-allocation of certain transactions in the GOQ (e.g., deferred transactions) occur at a transaction issue point on the system interconnect and may proceed simultaneously and independently with processing illustrated in process 800. Process 800 may start with an allocated GOQ in block 805. At block 810, the GOQ is checked to determine if there is any transaction in it. Processing at block 810 may be performed by scanning valid bits in the GOQ. If there is no valid bit that is set, the GOQ is empty. If the GOQ is empty, the caching bridge waits until the next processing unit issue point at block 815 and then check the GOQ again at block 810. Processing in blocks 810 and 815 may need to be repeated more than once until the GOQ has at least on transaction in it. If the GOQ is not empty, the oldest transaction may be identified in the GOQ at block 820.

At block 825, the identified oldest transaction at block 820 may be checked to determine if it is from the OTQ. This may be performed by identifying the oldest transaction in the OTQ and checking if this transaction the same as the oldest transaction from the GOQ. If they are the same, the oldest transaction from the GOQ is from the OTQ. Then, the transaction is further checked to determine if it is ready to be delivered to a processing unit for processing at block 830. If the oldest transaction from the GOQ is not from the OTQ (i.e., it is from the ITQ), it may be delivered to a corresponding processing unit for processing at block 845. If at block 830, it is determined that the oldest transaction in the GOQ, which is from the OTQ, is ready for processing, the transaction may be delivered to a corresponding processing unit for processing at block 845; otherwise, the ITQ is checked to determine if there is any transaction in it at block 835. If the ITQ is empty, the caching bridge waits until the next processing unit issue point at block 815 and then performs processing in blocks 820-835 again. If the ITQ is not empty, the oldest transaction in the ITQ may be identified at block 840. The identified transaction may be selected and be delivered to a corresponding processing unit for processing at block 845.

After the selected transaction at block 845 is delivered to a corresponding processing unit for processing, the transaction may be de-allocated from the GOQ at block 850. Then the process from block 810 until block 850 may be re-iterated so that global ordering may be enforced so long as the multi-processor system is running.

Although an example embodiment of the disclosed subject matter is described with reference to block and flow diagrams in FIGS. 1-8, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spope of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A bridge for coupling a first interconnect and a second interconnect, comprising:
a second-interconnect interface to couple said bridge with said second interconnect; and
scheduling and ordering logic to schedule transactions from at least one of said first interconnect and said second interconnect, said scheduling and ordering logic including an ordering mechanism to enforce global ordering among said transactions.

2. The bridge of claim 1, further comprising at least one first-interconnect interface to couple said bridge with said first interconnect.

3. The bridge of claim 1, wherein said first interconnect connects at least one processing unit with a shared cache, said shared cache being accessible by said at least one processing unit.

4. The bridge of claim 3, wherein said first bridge maintains coherency of cache lines in said shared cache.

5. The bridge of claim 1, wherein said IQOM comprises:
a first queue to record inbound transactions, said inbound transactions being sent from said second interconnect to said first interconnect;
a second queue to record outbound transactions, said outbound transactions being sent from said first interconnect to said second interconnect; and
a third queue to record transactions from said first queue and said second queue along with age information of each transaction.

6. The bridge of claim 5, wherein said third queue comprises an age order matrix and a column of valid bits.

7. The bridge of claim 5, wherein said ordering mechanism further comprises:
a first selector to select the oldest transaction in said first queue;
a second selector to select the oldest transaction in said second queue; and
a third selector to select the oldest transaction in said third queue.

8. The bridge of claim 7, wherein said ordering mechanism further comprises a controller to decide which transaction among transactions selected by at least one of said first selector, said second selector, and said third selector is delivered to a processing unit coupled to said first interconnect for processing.

9. The bridge of claim 8, wherein said controller enforces strict ordering among said inbound transactions and strict ordering among said outbound transactions.

10. A processor, comprising:
a bridge to couple a first interconnect and a second interconnect, said bridge including an inter-queue ordering mechanism (IQOM) to enforce global ordering among transactions from at least one of said first interconnect and said second interconnect; and
at least one processing core coupled to said first interconnect to send requests to said bridge and to process transactions selected and delivered by said bridge.

11. The processor of claim 10, wherein said bridge comprises:
at least one first-interconnect interface to couple said bridge with said first interconnect, each of said at least one first-interconnect interface corresponding to one of said at least one processing core;
a second-interconnect interface to couple said bridge with said second interconnect; and
scheduling and ordering logic to schedule transactions from at least one of said first interconnect and said second interconnect, said scheduling and ordering logic including said IQOM to enforce global ordering among said transactions.

12. The processor of claim 10, wherein said first interconnect connects said at least one processing core with a shared cache, said shared cache being accessible by said at least one processing core.

13. The processor of claim 10, wherein said bridge maintains coherency of cache lines in said shared cache.

14. The processor of claim 10, wherein said IQOM comprises:
a first queue to record inbound transactions, said inbound transactions being sent from said second interconnect to said first interconnect;
a second queue to record outbound transactions, said outbound transactions being sent from said first interconnect to said second interconnect; and
a third queue to record transactions from said first queue and said second queue along with age information of each transaction.

15. The processor of claim 14, wherein said third queue comprises an age order matrix and a column of valid bits.

16. The processor of claim 14, wherein said IQOM further comprises:
a first selector to select the oldest transaction in said first queue;
a second selector to select the oldest transaction in said second queue; and p1 a third selector to select the oldest transaction in said third queue.

17. The processor of claim 16, wherein said IQOM further comprises a controller to decide which transaction among transactions selected by at least one of said first selector, said second selector, and said third selector is delivered to a processing core coupled to said first interconnect for processing.

18. The processor of claim 17, wherein said controller enforces strict ordering among said inbound transactions and strict ordering among said outbound transactions.

19. A computing system, comprising:
a memory subsystem;
at least one bridge to couple a first interconnect and a second interconnect; and
a plurality of agents coupled to at least one of said first interconnect and said second interconnect to issue and process transactions, and to access data in said memory subsystem, through at least one of said first interconnect and said second interconnect;
wherein each of said at least one bridge includes an ordering mechanism to enforce global ordering among transactions from at least one of said first interconnect and said second interconnect.

20. The system of claim 19, wherein each of said at least bridge comprises:
at least one first-interconnect interface to couple said bridge with said first interconnect;
a second-interconnect interface to couple said bridge with said second interconnect; and
scheduling and ordering logic to schedule transactions from at least one of said first interconnect and said second interconnect, said scheduling and ordering logic including said ordering mechanism to enforce global ordering among said transactions.

21. The system of claim 20, wherein said first interconnect connects at least one processing unit with a shared cache, said shared cache being accessible by said at least one processing unit.

22. The system of claim 21, wherein each of said at least one first-interconnect interface corresponds to one of said at least one processing unit, said at least one processing unit including at least one of one of said plurality of agents and one processing core in one of said plurality of agents.

23. The system of claim 21, wherein said bridge maintains coherency of cache lines in said shared cache.

24. The system of claim 20, wherein said ordering mechanism comprises:
a first queue to record inbound transactions, said inbound transactions being sent from said second interconnect to said first interconnect;
a second queue to record outbound transactions, said outbound transactions being sent from said first interconnect to said second interconnect; and
a third queue to record transactions from said first queue and said second queue along with age information of each transaction.

25. The system of claim 24, wherein said third queue comprises an age order matrix and a column of valid bits.

26. The system of claim 24, wherein said ordering mechanism further comprises:
a first selector to select the oldest transaction in said first queue;
a second selector to select the oldest transaction in said second queue; and
a third selector to select the oldest transaction in said third queue.

27. The system of claim 24, wherein said ordering mechanism further comprises a controller to decide which transaction among transactions selected by at least one of said first selector, said second selector, and said third selector is delivered to a processing unit coupled to said first interconnect for processing, said processing unit including at least one of one of said plurality of agents and a processing core in one of said plurality of agents.

28. The system of claim 27, wherein said controller enforces strict ordering among said inbound transactions and strict ordering among said outbound transactions.

29. The system of claim 20, further comprising a chipset to couple said memory subsystem to said plurality of agents.

30. The system of claim 29, wherein said chipset comprises one of said at least one bridge.

31. The system of claim 20, wherein said plurality of agents comprises a processor having multiple processing cores, said processor including one of said at least one bridge.

32. A method for enforcing global ordering using an ordering mechanism in a computing system, comprising:
selecting a transaction in at least one transaction queue in said ordering mechanism; and
delivering said transaction to a processing unit in said computing system.

33. The method of claim 32, wherein said ordering mechanism is located in a bridge that couples a first interconnect and a second interconnect, said ordering mechanism comprising a first queue to record inbound transactions, a second queue to record outbound transactions, and a third queue to record all the inbound and outbound transactions with their corresponding age information.

34. The method of claim 33, wherein said inbound transactions comprise transactions traveling from said second interconnect to said first interconnect, and said outbound transactions comprise transactions traveling from said first interconnect to said second interconnect.

35. The method of claim 33, wherein selecting a transaction comprises:
identifying the oldest transaction in said third queue (“a third-queue oldest transaction”);
determining whether said third-queue oldest transaction is from said second queue; and
if said third-queue oldest transaction is from said second queue, determining whether to deliver said third-queue oldest transaction to said processing unit for processing.

36. The method of claim 35, wherein identifying said third-queue oldest transaction comprises:
checking said third queue to determine if said third-queue has any valid transaction;
if said third-queue does not have any valid transaction, waiting until the next issue point to check said third queue again; and
repeating the checking said third queue and the waiting, if necessary, until said queue has at least one valid transaction.

37. The method of claim 35, wherein determining whether to deliver said third-queue oldest transaction to said processing unit for processing comprises:
determining whether said third-queue transaction is ready to be delivered to said processing unit for processing; and
if said third-queue oldest transaction is not ready, identifying the oldest transaction in said first queue.

38. The method of claim 37, wherein identifying said first-queue oldest transaction comprises:
checking whether said first queue has any valid transaction; and
if said first queue does not have any valid transaction, waiting until the next processing unit issue point.

39. The method of claim 32, further comprising de-allocating said transaction after said transaction is delivered to said processing unit for processing.

40. The method of claim 32, further comprising:
allocating a new transaction into at least said third queue; and
de-allocating a transaction from at least said third queue when said transaction is deferred.

41. An article comprising a machine readable medium that stores data representing an integrated circuit comprising a bridge to coupling a first interconnect and a second interconnect, said bridge including:
at least one first-interconnect interface to couple said bridge with said first interconnect;
a second-interconnect interface to couple said bridge with said second interconnect; and
scheduling and ordering logic to schedule transactions from at least one of said first interconnect and said second interconnect, said scheduling and ordering logic including an ordering mechanism to enforce global ordering among said transactions;
wherein said first interconnect connects at least one processing unit with a shared cache, said shared cache being accessible by said at least one processing unit.

42. The article of claim 41, wherein said ordering mechanism comprises:
a first queue to record inbound transactions, said inbound transactions being sent from said second interconnect to said first interconnect;
a second queue to record outbound transactions, said outbound transactions being sent from said first interconnect to said second interconnect; and
a third queue to record transactions from said first queue and said second queue along with age information of each transaction, said third queue including an age order matrix and a column of valid bits.

43. The article of claim 42, wherein said ordering mechanism further comprises:
a first selector to select the oldest transaction in said first queue;
a second selector to select the oldest transaction in said second queue;
a third selector to select the oldest transaction in said third queue; and
a controller to decide which transaction among transactions selected by at least one of said first selector, said second selector, and said third selector is delivered to a processing unit coupled to said first interconnect for processing.

44. The article of claim 41, wherein said controller enforces strict ordering among said inbound transactions and strict ordering among said outbound transactions.
